(19) United States
(12) Patent Application Publication
(10) Pub. No.: US 2008/0154878 A1
(43) Pub. Date: Jun. 26, 2008

(54) Diversifying a set of items

(76) Inventors: Daniel E. Rose, Cupertino, CA (US); Swati Raju, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/643,473

(22) Filed: Dec. 20, 2006

(51) Int. Cl. G06F 17/30

(52) U.S. Cl. 707/5; 707/E17.014

(57) ABSTRACT

Techniques are described hereafter for diversifying search results by ranking the search results based, at least in part, on a diversifying factor. In one embodiment, the diversifying factor is used to generate diversity scores for the matching documents. Matching items that are very different from other highly-ranked matching items are assigned high diversity scores, and have their rankings improved based on their diversity scores. Conversely, matching items that are very similar to other highly-ranked matching items are assigned low diversity scores, and have their rankings reduced based on their diversity scores. Techniques are also described for re-ranking search results in response to user input without any additional interaction with the search engine. Techniques are also described for generating tag clouds that indicate the concepts associated with the currently-presented set of search results, where a visual characteristic of the tags reflects how strongly the corresponding concepts reflect the currently-presented set of search results.

### FIELD OF THE INVENTION

The present invention relates to searches and, more specifically, to ranking the results of a search based, in part, on a diversifying factor.

### BACKGROUND

In response to a search query, search engines typically return a list of items that match the search criteria specified in the search query. Before returning the list of matching items to the user, the search engine typically scores the matching items based on an estimate of the likelihood that the matching items will be of interest to the user, and then ranks the matching items based on the score.

Scores that are assigned to matching items based on how likely the matching items will be of interest to a user are referred to herein as “relevance scores”. The rank that is assigned to a matching item based on its relevance score is referred to herein as the matching item's “relevance ranking”.

The number of items that match a search query is frequently too high to allow all matching items to be displayed to the user at the same time. Therefore, search engines typically present the matching items in an order based on the relevance rankings. Thus, the search engines initially provide a web page that lists the top N matching items, ordered based on relevance ranking. The web page of search results that a search engine initially presents to the user is referred to herein as the “initial results page”.

Typically, the number N of items listed in the initial results page is a very small number (e.g. 5 to 10) relative to the total number of matching items, which can be in the thousands. Consequently, the initial results page usually includes a control which, when selected, causes the search engine to provide a web page with listings for the next N items, relative to the order established by the relevance ranking.

By ordering the matching items based on the relevance rankings of the matching items, and providing search results pages to users based on that order, search engines make it easy for most users to quickly identify those matching items that are most likely to be of interest to the users. However, presenting search results in an order that is based on relevance ranking may not be helpful to some users. Specifically, ranking and presenting search results based on relevance scores works well for those users that submit a search query with the same intent as most other users that submit the same search query. Such users are referred to herein as “common-intent users”. For example, if 90% of the users that submit the search query “flowers” are looking to order flowers, then florist web sites are going to have high relevance scores relative to the search query “flowers”. Therefore, the high ranks of the search result listing for “flowers” will be dominated by florist sites, which is exactly what the common-intent users would like to see.

However, for users that submit a search query with a different intent than most other users that submit the same search query, relevance ranking does not work so well. Such users are referred to herein as “uncommon-intent users”. For example, 5% of users that submit the search query “flowers” may actually be doing research relating to flowers. To those users, florist web sites would be irrelevant, while web sites that contain scientific information about flowers may be highly relevant. However, because the common-intent users have a different intent, the relevance scores are skewed towards ordering flowers. Consequently, the flower researcher will be presented with search results in which florist sites dominate the high rankings. To locate the listings for scientific web sites related to flowers, the researcher may have to page through many pages of higher-ranked florist listings.

Even common-intent users may consider it a waste of time to scan through results that contain no new information. Once the main goal of a common-intent user is satisfied by one or two highly-ranked items, instead of showing users more of the same, a search engine could use the available space to show users other information that might be of interest. For example, consider a newspaper. In a newspaper, there is a lead story, and then next to the lead story is a “sidebar” that investigates a related topic, gives background to the main story, does some analysis, or otherwise puts it in perspective. The sidebar would be useless if the sidebar gave exactly the same information as the main story. It would be equally unhelpful to have the whole front page of the newspaper filled with different versions of the same story.

Based on the foregoing, it would be desirable for search engines to strike a better balance between the interests of common-intent users and the interests of uncommon-intent users. In particular, it would be desirable to order the search results so that the matching items that are most relevant to uncommon-intent users are ranked high, along with the matching items that are most relevant to the common-intent users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating search results ranked based on relevance;

FIG. 2 is a block diagram illustrating search results ranked based on a low degree of diversification, according to an embodiment of the invention;

FIG. 3 is a block diagram illustrating search results ranked based on a high degree of diversification, according to an embodiment of the invention;

FIG. 4 is a flowchart illustrating how diversity rankings may be generated using the already-ranked technique, according to one embodiment; and

FIG. 5 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques are described hereafter for “diversifying” search results by ranking the search results based, at least in part, on a “diversifying factor.” As used herein, the term “diversifying factor” refers to any factor that alters the ranking of a matching item, relative to other matching items, based on how different the matching item is from other matching items. In one embodiment, the diversifying factor is used to generate diversity scores for the matching documents. Matching items that are very different from other highly-ranked matching items are assigned high diversity scores, and have their rankings improved based on their diversity scores. Conversely, matching items that are very similar to other highly-ranked matching items are assigned low diversity scores, and have their rankings reduced based on their diversity scores.

The differences upon which the diversity scores are based will vary from implementation to implementation depending on the type of diversification that is desired. For example, diversity scores may be based on differences between the subject matter of the matching items to impose “subject matter diversity” in the ranking of search results. As another example, diversity scores may be based on differences in item types to impose item-type diversity in the ranking of search results.

Techniques are also provided for presenting, along with the listings of a subset of the matching items, a visual indication of the subject matter reflected in that particular subset of matching items. According to one embodiment, the listings of the subset of matching items are sent to the user in the form of a web page, and the search engine includes in that web page a “tag cloud” that includes terms logically connected with the matching items listed on that web page. In one embodiment, a visual characteristic (e.g. size, color, etc.) of the tags in the tag cloud is used to reflect how strong the logical connection is between the tags and the matching items.

### Types of Matching Items and Searches

Search engines that search for web pages are probably the most commonly-used type of search engine. However, the techniques described herein are not limited to web page searches. Rather, the techniques may be applied to searches in any context. For example, the techniques may be equally applied by search engines that are used to search for songs, videos, music, bookmark sets, white page listings, people, etc. For the purpose of illustration, various embodiments shall be described in the context of web page searches. However, the invention is not limited to any particular type of search engine, or to searches run against any particular type of items.

In addition, the invention is not limited to items being searched on the Internet. For example, the techniques described herein could also be used for searches for files on a user's file system, e-mail messages, etc. A search engine does not have to be a client-server system to employ these techniques. For example, the search engine that employs these techniques could be a single application or even an integrated part of the operating system. Further, the device doing the searching does not have to be a personal computer. It could be any computing device (PDA, cell phone, etc.).

### Types of Diversification

The differences that are used to generate diversity scores determine the type of diversification that will result from using the diversity scores to rank search results. Thus, to diversify search results based on subject matter, differences between the subject matter of matching items are used to generate the diversity scores. For example, low diversity scores will be generated for items that are on the same topic as other highly-ranked items, while high diversity scores will be generated for items that are on topics that are unrelated to the topics of other high-ranked items.

On the other hand, to diversify search results based on item type, differences between the item types of matching items are used to generate the diversity scores. For example, low diversity scores will be generated for items that are of the same type as other highly-ranked items, while high diversity scores will be generated for items that are of different types than other high-ranked items. As a specific example of item type diversification, assume that three files have already been highly-ranked in a file search. Assume further that all three highly-ranked files are text files. Under these conditions, the search engine may generate relatively high diversity scores for .pdf files, PowerPoint files, and spreadsheets, and relatively low diversity scores for other matching text files.

There is virtually no limit to the types of diversification that can be achieved using the techniques described herein. For example, “creator diversification” may be achieved by generating diversity scores based on differences between the creators of matching items. “Source diversification” may be achieved by generating diversity scores based on differences between the sources (e.g. web sites) of items. “Geographic diversification” may be achieved by generating diversity scores based on differences in locations associated with the items. In the context of music searches, “duration diversification” may be achieved by generating diversity scores based on differences in the durations of songs. In the context of merchandise searches, “price diversification” may be achieved by generating diversity scores based on differences between the prices of products that matched a search. For the purpose of illustration, examples of search diversification techniques shall be given hereafter in the context of subject matter diversification of web pages. However, the invention is not limited to any particular form of diversification.

### Example: Subject Matter Diversification

Subject matter diversification is one way to balance the needs of common-intent users with uncommon-intent users. The highest-ranked items in a search result listing that has been diversified based on subject matter will still include one or more items that are highly relevant to common-intent users. However, unlike undiversified relevance-based search results, the highest-ranked items of a diversified search result listing are much more likely to also include items that are highly relevant to uncommon-intent users.

In diversified results, items that are highly-relevant to uncommon-intent users will have supplanted, in the top rankings, some items that may be highly relevant to common-intent users. However, the absence of the supplanted items from the top rankings will usually not have a significant adverse effect on the experience of common-intent users, since the supplanted items are likely to be highly redundant with other items that are in the top ranks of the diversified results.

For example, in the undiversified, relevance-ranked search results produced by the search query “flowers”, the five highest-ranked items may all correspond to florists. In the subject-matter-diversified search results produced by the query “flowers”, only one of the top five items may correspond to a florist. The other top items may include, for example, a web page containing scientific information about flowers, a web page associated with a movie that contains “flowers” in the title, a personal web page about someone with the name “flowers”, etc. In this example, the highest ranked items still allow a common-intent user to quickly and easily order flowers from a florist. The fact that the common-intent user initially sees the listing of only one florist, rather than five, may not be important to the common-intent user. However, with the diversified search results, the uncommon-intent user is able to quickly locate scientific information about flowers, without having to page through several search results pages of florist-oriented listings in which the uncommon-intent user has no interest.

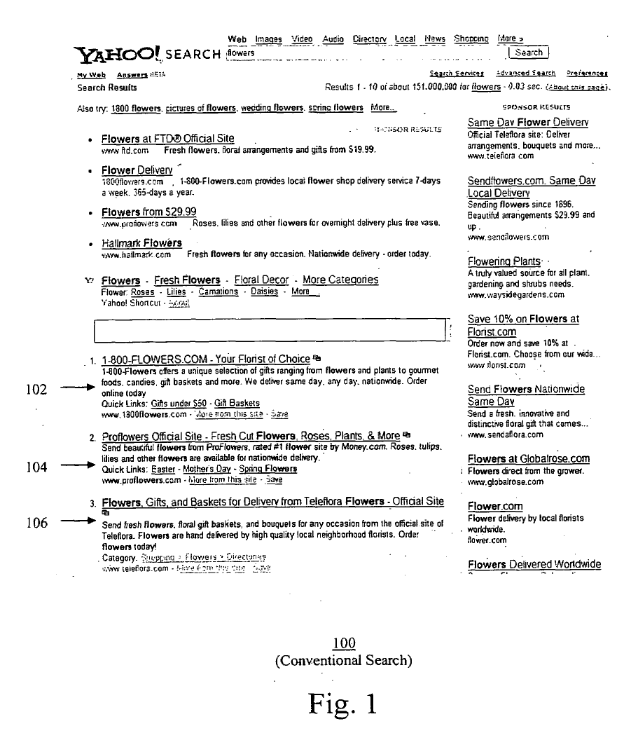

Referring to FIG. 1, it is a block diagram of an initial results page 100 for the query “flowers”, produced by a search engine using conventional relevance rankings. The initial results page of FIG. 1 includes listings for three of the matching items. In this example, the three matching items are web pages identified by the listings 102, 104 and 106. As would be expected, each of the three listings 102, 104 and 106 is for a florist web site, which would be highly relevant to common-intent submitters of the query “flowers”.

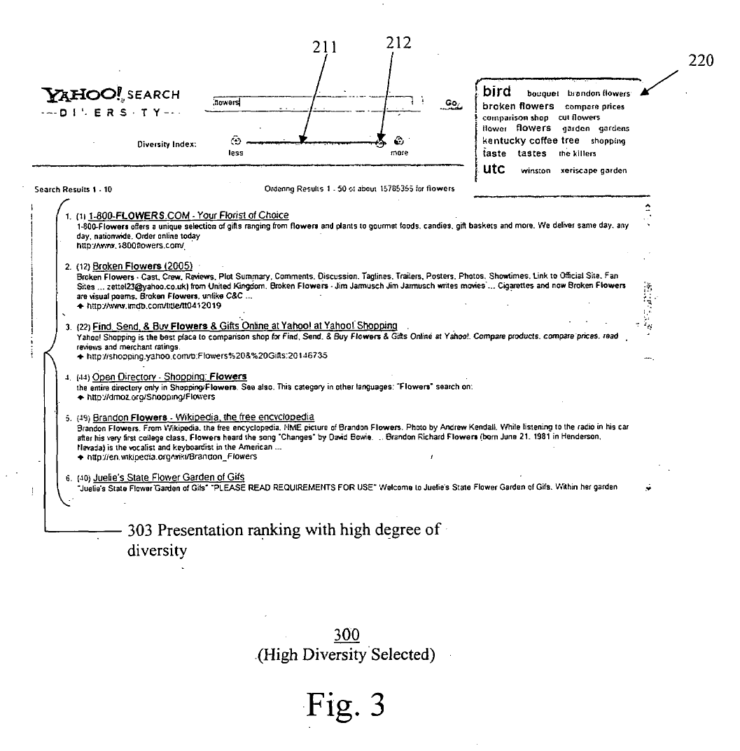

FIG. 3 is a block diagram of an initial results page 300 for the same search query “flowers”. However, the search engine that produced the initial results page 300 used a diversifying factor, in addition to relevance, to determine the ranked order in which to present the matching items. Consequently, the listings 303 on results page 300 include only one listing for a florist web site. The other listings correspond to other types of web sites, such as shopping services, movies, etc.

### Diversification Techniques

The diversity rankings of items can be determined in a variety of ways. For example, using a “clustering” technique, diversity rankings are determined by dividing a set of items into conceptually related clusters of items, and then assigning rankings in a manner that ensures that the highest ranking items include items from each of the various clusters.

In one embodiment of the clustering technique, each cluster may be equally represented by selecting items from the clusters in a round-robin fashion. Thus, if there are three clusters A, B, and C, the highest ranking may be assigned to an item from cluster A, the second highest to an item from cluster B, the third highest to an item from cluster C, and the fourth highest to another item from cluster A.

In an alternative embodiment of the clustering technique, each cluster is represented in the highest rankings in proportion to the number of items in the cluster. For example, assume that clusters A, B, and C have 100, 700 and 200 items, respectively. In this case, the rankings may be assigned in manner that ensures that the ten highest ranked items include one item from cluster A, seven items from cluster B, and two items from cluster B. When such “proportional” assignments are made, the ranking mechanism may be further configured to ensure that every cluster has at least one item in the highest ranks, even though the number of items in the cluster would not otherwise result in any representation.

Using a “scoring” technique, diversity rankings are determined based on diversity scores that indicate how different an item is from other items. A variety of techniques shall be described hereafter for generating diversity scores.

Clustering and scoring are merely two examples of ways in which diversity rankings may be determined. The search result diversification approaches described herein are not limited to any particular technique for generating diversity rankings.

### Generating Diversity Scores

According to one embodiment, a search engine includes a mechanism for generating diversity scores that indicate how different one item is from one or more other items. The set of items against which an item is compared, for the purpose of generating the diversity score, is referred to herein as the “comparison set”. The manner in which such diversity scores are generated will vary from implementation to implementation based on a variety of factors, including the diversification factor that is being used as the basis for generating the diversity scores.

In some cases, the diversity score mechanism may be relatively simple. For example, to diversify search results based on file type, the diversification factor would be “type of file”. Under these conditions, the diversity score for an item may be generated based on how many items in the comparison set have the same file type as the item. For example, the diversity score may be “0” when all of the items in the comparison set have the same file type as the item, “1” when none of the items in the comparison set have the same file type as the item, and “0.5” when half of the items in the comparison set have the same file type as the item.

In other situations, the diversity score mechanism may be more complex. For example, to diversify search results based on the concepts to which the items relate, a “concept vector” associated with each item may be compared against a “concept vector” associated with the comparison set. The concept vector that represents the comparison set is referred to herein as the “comparison vector”. The concept vector that is associated with the item for which a diversity score is being generated is referred to herein as the “target vector”. The generation of target and comparison vectors shall be described in greater detail hereafter.

By comparing the target vector to the comparison vector, a diversity score for the item may be generated to reflect the degree to which the target vector differs from the comparison vector. A variety of techniques may be used to generate diversity scores that reflect the difference between two concept vectors. For example, the diversity scores may be computed based on the cosine of the angle between the target vector and the comparison vector. Since the cosine of the angle approaches zero as the angle gets wider, the diversity scores may be computed as (1−cosine of the angle). One way to obtain (1−cosine of the angle) involves normalizing each of the vectors so that its Euclidean length is 1, and then taking the inner product of the vectors.

Normalizing and taking the inner product is mathematically equivalent to computing the cosine. However, if all the vectors are always kept normalized, then the similarity calculation only involves computing the inner product. Consequently, in cases where many comparisons need to be performed, taking the inner product might be more computationally efficient.

As yet another example, the diversity score for the target vector may simply be 1−(the number of concepts the target vector has in common with the comparison vector/total number of concepts in a target vector). These are merely examples of ways to generate the diversity scores for concept vectors. The invention is not limited to any particular technique for determining the degree of difference between concept vectors.

### Generating Target and Comparison Vectors

Embodiments that use concept vectors to generate diversity scores may use a variety of techniques to generate the target and comparison vectors upon which diversity scores are based. According to one embodiment, the concept vectors for individual items are generating using the techniques described U.S. Pat. No. 6,947,930 issued to Anick et al. on Sep. 20, 2005 (the “Anick patent”), the contents of which are incorporated herein by reference.

Using the techniques described in the Anick patent, the concept vector for a web page about “Activities that Practice Geometry and Measurement Concepts” may have the following form:
40 fractals/fractal
23 triangles/triangle
21 number patterns
18 generation
15 geometric properties
15 parameters
15 shapes/shape
15 sequences
15 polygon/polygons
12 geometric fractals
11 fractal patterns
11 geometric fractal
11 pascal's triangle
9 deforming
9 fractal dimensions
9 squares/square
8 sierpinski's triangle
8 fractal julia
7 tesselations/tessellation
7 planes/plane

Vectors may also be expressed as a list of term-weight pairs, such as: (fractals/fractal 40, triangles/triangle 23, number patterns 21, etc.).

This example vector represents several “concepts”. Each concept is represented by a set of terms or phrases. In some cases, such as the concept “fractal/fractals”, a concept is associated with a set of equivalent terms. To match a concept that is associated with equivalent terms, the document would only need to have one of the terms, not both.

Within the vector, each concept is assigned a concept weight. Specifically, the concepts “fractal/fractals”, “number patterns” and “shapes/shape” have respective concept weights of 40, 21 and 15. According to one embodiment, the concept weight assigned to each concept in a concept vector indicates how well the concept represents the subject matter of the item associated with the concept vector. The weights within the concept vectors may be normalized relative to the weights in other vectors so that they are commensurate when combined with or otherwise compared to other vectors, as shall be described in greater detail hereafter.

According to one embodiment, the concept vector that is generated for any given item is used as the target vector when generating the diversity score for the item. Comparison vectors, in turn, are generated by combining the concepts that belong to the concept vectors of all items that belong to comparison sets. For example, assume that a comparison set includes item A and item B. If the concept vector for an item A includes concept A, and the concept vector for an item B includes concept B, then the comparison vector for a comparison set that includes items A and B will include concepts A and B.

According to one embodiment, when generating the comparison vector, the concept weights from the vectors of the items that belong to the comparison set are adjusted in way that ensures that the concept weights in the resulting comparison vector gives equal weight to the items that belong to the comparison set. For example, when a new item is added to a comparison set that already contains five items, a new comparison vector has to be generated for the comparison set. However, when generating the new comparison vector, the concept weights associated with the concepts of the newly added item are not given equal weight with the concept weights of the concepts that are in the current comparison vector. To do so would ignore the fact that the current comparison vector represents the concepts of five items, each of which should be given equal weight with the newly added item.

According to one embodiment, the fact that the current comparison vector reflects five items is taken into account by, when generating the new comparison vector, giving the concept weights of the current comparison vector five times the weight as the concept weights of the vector of the newly added item. This may be accomplished, for example, by multiplying the concept weights in the current comparison vector by ⅚, and the concept weights in the vector of the newly added item by ⅙. More generally, whenever any single-item vector is merged into a current comparison vector to produce a new comparison vector, the concept weights in the single item vector may be multiplied by 1/n, while the concept weights in the current comparison vector are multiplied by (n−1)/n, where n is the number of items that will be reflected in the new comparison vector.

Adjusting the concept weights in this manner produces a comparison vector that is the average of all the vectors of the items in the comparison set. For instance, where all the individual vectors are available simultaneously, in one implementation, the vectors may simply be added algebraically, and their sum divided by the total number of combined vectors to obtain the comparison vector.

For example, where four (4) vectors W, X, Y, Z are available, the comparison vector A is given with Equation 1, below

A=(W+X+Y+Z)/4 (Equation 1).

### Algebraically however, this is equivalent to Equation 2, below.

A=W/4+X/4+Y/4+Z/4 (Equation 2).

Equations 1 and 2 are further expressible in algebraically equivalent decimal terms, as in Equation 3, below.

A=0.25W+0.25X+0.25Y+0.25Z (Equation 3).

In this example, the numbers “0.25” function as the weights given to each vector, which ensures each vector's fair representation in the average.

With one implementation however, e.g., a number N of vectors (in the case illustrated with Equations 1-4, N=4), not all of the vectors are initially functionally present or used. A situation is essentially sustained in which an “old” comparison vector represents the average of (N−1) individual vectors (in the case illustrated with Equations 1-4, (N−1)=3). Thus, given the old comparison vector A′, which contains the average of the vectors W, X, and Y, an issue remains as to how best to add the vector Z. For example, were the vector Z simply added, or averaged with the old aggregate A′, that would result in the vector Z being “unfairly” represented (e.g., given undue weight). In such a hypothetical situation, the vector Z would count as much as W, X and Y taken together.

To avoid this undue weighting of single vectors as they are added, one embodiment essentially considers the weight on the vector Z where all four vectors, W, X, Y and Z subjected to averaging as vector Z is added. That vector Z weight is considered to be a value of 0.25. The present embodiment also considers the combined weight of vectors W, X and Y at this point. That weight for vectors W, X and Y is considered to be a value given by: 0.25+0.25+0.25, which is equal to 0.75. Thus, the weighted value of the comparison vector A is considered to be given by:

A=0.75A′+0.25Z (Equation 4).

Thus, comparison vector A will be the same as if all of the vectors were essentially averaged together in the first place. The weights used in this process in the present implementation are the value 0.75 and the value 0.25.

Somewhat more generally, one implementation computes a weighted average of the old comparison vector and the vector of a “new” document (e.g., a document whose vector is being added to the old comparison vector), where the weights are given by

(N−1)/N

and, for the process of adding the Nth document:

1/N (Equations 5A & 5B).

### Determining Comparison Sets

As mentioned above, diversity scores are generated by comparing information about one item (e.g. a target vector) against information about a comparison set of items (e.g. a comparison vector). Therefore, the diversity score of an item is largely dictated by the membership of the comparison set against which the item is compared. If the members of the comparison set against which the item is compared are similar to the item, then the diversity score of the item will be low. Conversely, if the members of the comparison set against which the item is compared are different from the item, then the diversity score of the item will be high.

Various techniques may be used to determine which items to include in the comparison set that is used to generate the diversity score for an item. For example, an “all-inclusive” technique would be to include all other to-be-scored items in the comparison set used to score every item. For example, assume that diversity scores are to be generated for ten documents. Using the all-inclusive technique, the comparison set for the each of the ten documents would include the nine other documents. In an embodiment that uses concept vectors, the diversity score for each document would be generated based on a comparison between the concept vector of the document with an aggregate concept vector that represents the concepts in the other nine documents.

Generating diversity scores using the “all-inclusive” technique may involve a significant amount of overhead when the number of to-be-scored items is great. Specifically, to create the comparison vectors required by the technique, N−1 concept vectors have to be combined N times, where N is the number of items in the to-be-scored population.

As an alternative to the all-inclusive technique, membership of the comparison sets can be established based on an “already-ranked” technique. According to the already-ranked technique, the membership of the comparison set against which each item is scored includes only those items that have already been assigned diversity rankings. Initially, no items will have been assigned diversity rankings. Therefore, the already-ranked set of items will be empty. Therefore, to begin to score items using the already-ranked technique, one or more items must be assigned diversity rankings based on factors other than the diversity scores.

According to one embodiment, the already-ranked technique is used to rank items that match a search query, and the highest diversity rank is assigned to the matching item that has the highest relevance score. Assigning the highest diversity rank to the matching item with the highest relevance score ensures that, even when ranked according to diversity, the highest-ranked search results include the item that is highly relevant to common-intent users.

After the item with the highest relevance score has been assigned the highest diversity rank, the already-ranked set is no longer empty. Consequently, diversity scores may be generated for each of the remaining items using the already-ranked set as the comparison set.

After the diversity scores for the remaining items have been generated, the top N of those items may be assigned diversity rankings, and added to the already-ranked set of items. Once those items have been added to the already-ranked set of items, the process may be repeated to assign relevance rankings to N more items. This process may be repeated until all matching items have been assigned diversity rankings. However, the process may be stopped as soon as the desired amount of highest-ranked items have been identified. Specifically, it is only necessary to repeat the process until all matching items have been assigned rankings if a complete diversity ranking of all matching items is desired. Such a complete ranking may be desired, for example, in order to do a dynamic blending of the original ranking and the diverse ranking. However, if all that is needed is the top M most diverse results (where M is less than the number of items that are in the pool being considered during the ranking process), then the cycle would only have to be repeated M times.

The all-inclusive technique, and the already-ranked technique, are merely examples of the techniques by which the membership of comparison sets may be determined. The present invention is not limited to any particular technique for determining the membership of comparison sets. For example, in alternative embodiments, the initial comparison set may simply include a set of manually-selected items, or items that have been automatically selected based on some criteria. In yet another alternative embodiment, the comparison set may include all items from one or more specific populations. For example, an “indexed-page” concept vector may be used to represent the weights of concepts of all web pages that have been indexed by a search engine. To generate diversity scores, the concept vector of individual web pages may be compared against the indexed-page concept vector.

### Example: Using the Already-Ranked Technique to Generate Diversity Ranking for Search Results

For the purpose of illustration, assume that the search results of a search query includes 10,000 items, and that the 10,000 items have been ranked based on relevance. Under these circumstances, generating diversity ranks for all 10,000 items may involve a significant amount of overhead. Therefore, in one embodiment, diversity ranks are generated for only the N items with the highest relevancy rankings. N may be any number, but should generally be large enough to ensure that it includes the items that are most relevant to both common-intent users and uncommon-intent users. However, N should not be so high as to make the diversity ranking operations prohibitively expensive. For the purpose of illustration, it shall be assumed that N is 50. Thus, even though the search results include 10,000 items, diversity rankings are generated for only the 50 matching items that received the highest relevancy rankings.

The already-ranked technique is an iterative process. During the first iteration, the “already-ranked” set of items is seeded with an item, and the concept vector for that item is established as the initial concept vector for the already-ranked set. During each subsequent iteration, (1) diversity scores are generated for all of the not-yet-ranked items based on the concept vector of the already-ranked set, (2) one or more of the not-yet-ranked items are assigned diversity rankings (thereby becoming members of the already-ranked set), and (3) the concept vector of the already-ranked set is updated to reflect the new members of the already-ranked set.

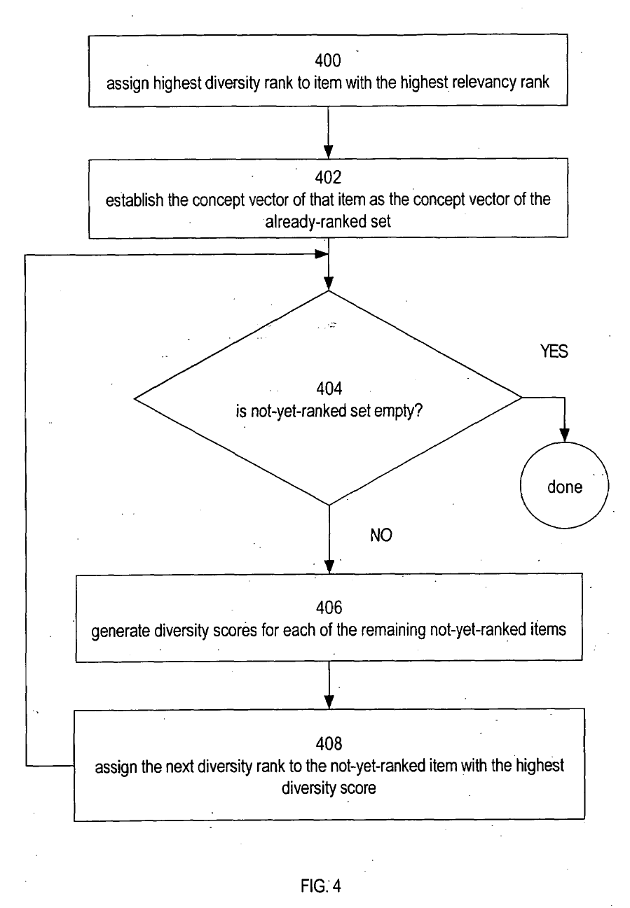

FIG. 4 is a flowchart illustrating how diversity rankings may be generated using the already-ranked technique, according to one embodiment. The embodiment illustrated in FIG. 4 is an embodiment in which the already-ranked set is seeded with a single item, and in which only one additional item is assigned a diversity ranking during each iteration. However, in alternative embodiments, the already-ranked set may be seeded with any number of items, and any number of items may be assigned diversity rankings during each iteration.

Prior to generating diversity rankings using the already-ranked technique, the items may be ordered based on their relevance rankings. However, while the relevancy ordering does not dictate the diversity rankings, it may be used to select the initial seed for the already-ranked set, and to break ties, as shall be described in greater detail hereafter. Referring to FIG. 4, at step 400 the item with the highest relevancy rank is assigned the highest diversity rank. At step 402, the concept vector of that item is established as the concept vector of the already-ranked set. Therefore, at the end of the first iteration of an operation in which 50 items are to be ranked, the already-ranked set will include the item with the highest relevancy rank, and the not-yet-ranked set will include the remaining 49 items.

At step 404, it is determined whether the not-yet-ranked set is empty. If the not-yet-ranked set is empty, then all of the to-be-ranked items have been ranked, and the diversity ranking process is done. Otherwise, control proceeds to step 406 to begin the next iteration. After the first iteration, the not-yet-ranked will still contain 49 items, so control proceeds to step 406 for the second iteration. As mentioned above, in some situations it may not be necessarily or desirable to determine diversity rankings for all items in the pool of items that are being ranked. For example, if only the M most diverse items are needed, then at step 404 it would be determined whether the already-ranked set has M members. If so, then the diversity ranking process would be stopped.

At step 406, during the second iteration, diversity scores are generated for each of the remaining 49 not-yet-ranked items by comparing the concept vector of each not-yet-ranked item with the concept vector of the already-ranked set (which at this point is the same as the concept vector of the item with the highest relevance ranking). The item with the highest diversity score relative to the concept vector of the already-ranked set is then assigned the second highest diversity rank (step 408). In the case that two or more items share the highest diversity score, other factors may be used to break the tie. For example, the original relevance score of an item may be used to break the tie when multiple items share the highest diversity score. Alternatively, in any given iteration, the search engine may assign diversity ranks to all items that are tied for the highest diversity score.

At this point, the item(s) that were assigned diversity ranks in step 408 are also added to the already-ranked set by merging the concept vector(s) of those item(s) into the concept vector of the already-ranked set (step 410). This vector merging process may be accomplished as previously described, in order to ensure that all already-ranked items receive equal representation in the concept vector of the already-ranked set. Control then returns to step 404.

At step 404, it is determined whether the not-yet-ranked set is empty. If the not-yet-ranked set is empty, then all of the to-be-ranked items have been ranked, and the diversity ranking process is done. Otherwise, control proceeds to step 406 to being the next iteration. After the second iteration, the not-yet-ranked will still contain 48 items, so control proceeds to step 406 for the third iteration.

At step 406, during the third iteration, diversity scores are generated for each of the remaining 48 not-yet-ranked items by comparing the concept vector of each not-yet-ranked item with the concept vector of the already-ranked set. The item with the highest diversity score relative to the concept vector of the already-ranked set is then assigned the third highest diversity rank (step 408). At this point, the item with the highest diversity score is also added to the already-ranked set by merging the concept vector of that item into the concept vector of the already-ranked set (step 410). Control then returns to step 404.

Steps 404, 406 and 408 form a loop which is repeated until all to-be-ranked items have been assigned diversity rankings. Thus, at the end of the ranking process, all items will belong to the already-ranked set, and the not-yet-ranked set will be empty.

In the above example, it was assumed that each iteration produced a single “highest” diversity score. However, it is possible that multiple not-yet-ranked items will be tied with the highest diversity score. Various techniques may be used to handle such “tie” situations. According to one embodiment, all items that are tied for the highest diversity score may be ranked and added to the already-ranked set. In another embodiment, some criteria unrelated to diversity may be used to select which of the tied items is added to the already-ranked set. For example, in one embodiment, the tied item that has the highest relevance score is added to the already-ranked set.

### Presentation Rankings Based on Diversity Rankings

According to one embodiment, diversity rankings are used to determine the order in which search results are presented to a user. The order in which items are presented to users is referred to herein as the presentation ranking of the items.

In conventional search engines, the presentation ranking of each item is the same as the relevance ranking of the item. This is the case with the search results depicted in FIG. 1. In contrast, with search engines that employ the diversification techniques described herein, the presentation rankings are based, at least in part, on diversity rankings that have been assigned to the items. For example, in the search results illustrated in FIG. 3, the presentation ranking of each item is the same as the diversity ranking assigned to the item during the diversification process.

In some cases, it may not be desirable have the presentation rankings dictated exclusively by the diversity rankings. For example, some users may find that the best presentation rankings, relative to their interests, are achieved by determining the presentation rankings based partially on the relevance rankings, and partially on the diversity rankings.

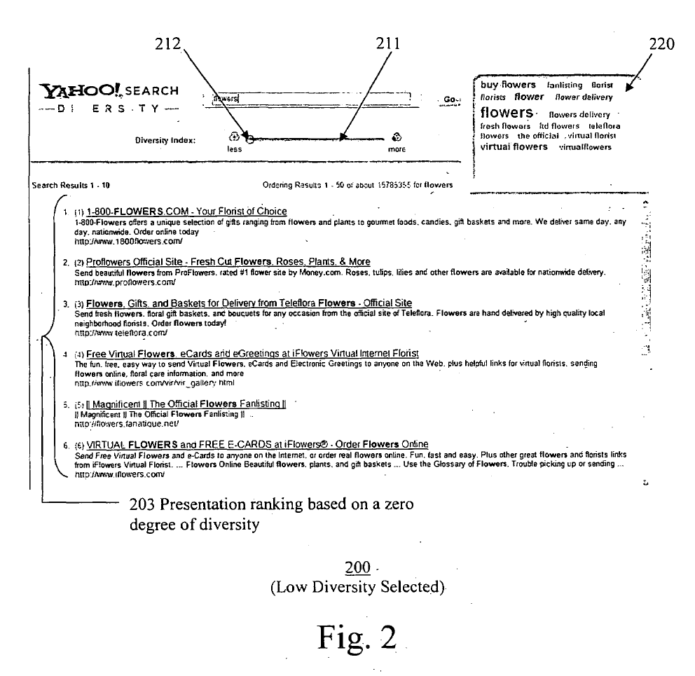

When the presentation ranking takes both relevance rankings and diversity rankings into account, the results will vary based on how much weight is given to each type of ranking. Techniques for adjusting the weights given to the relevance and diversity rankings are described in greater detail below. If no weight is given to the diversity rankings, then the presentation ranking will be the same as the relevance rankings, as illustrated in FIG. 2.

In the search results depicted in FIG. 3, the items are ranked according to a presentation ranking that takes into account the diversification factor. Due to the effect of the diversification factor, the presentation rankings differ from the relevance rankings. In the embodiment illustrated in FIGS. 2 and 3, each item listing includes a parenthetical indicator that identifies the item's relevance ranking. For example, in FIG. 3, the parenthetical indicators contained in the first six item listings indicate relevance rankings of 1, 12, 22, 44, 49, and 40, respectively. In addition, the listings illustrated in FIG. 3 also include arrows indicating whether the presentation ranking of the item is higher or lower than its relevance ranking.

### Adjusting the Weight of the Diversification Factor

As mentioned above, the presentation ranking of items may be based on both relevance and diversity. For example, the presentation ranking may be based on “presentation scores”, where the presentation score for each item is generated based on the item's relevance ranking and diversity ranking. In generating the presentation scores, the relative weights given to the relevance rankings and diversity rankings may be adjusted to suit particular needs.

Relevance rankings are merely one example of a factor that may be used, in conjunction with the diversification factor, to determine the presentation ranking of items. For the purpose of explanation, a scenario shall be described hereafter in which items are ranked based on diversity and some other factor. The rankings produced by the other factor are referred to herein as the “first rankings”. In one embodiment, the other factor is relevance, and the first rankings are the relevance rankings. However, in alternative embodiments, the first ranking may be based on factors other than relevance.

In one embodiment, a significance weighting is used to ascribe a relative importance to the first (e.g., original) ranking and the subsequent (e.g., diverse) ranking. For example, a list of documents a, b, c, d and e is ranked originally (e.g., in a first ranking) in an order reflective thereof: document a is ranked as first, document b as second, document c as third, document d as fourth and document e as fifth. In diversity rankings, however, the ranking order may vary significantly from the order a, b, c, d and e of the first ranking. For example, in the diversity rankings, the order may be a, e, c, b and d.

Another way to view this variation is that the ranking order for [a, b, c, d, e] is initially [1, 2, 3, 4, 5], e.g., from the first ranking thereof. However, after diversifying the results with the second ranking, the order for [a, b, c, d, e] changes to [1, 4, 3, 5, 2]. In this example, document a retains the first rank in the second ranking that it had in the first ranking. The document b however moved from the second to the fourth rank, from the first ranking to the more diverse subsequent ranking. Likewise, document e moved from the fifth rank to the second rank, and document d from the fourth rank to the fifth rank, from the first ranking to the more diverse subsequent ranking. This variation is summarized in Table 1 below.

TABLE 1

| Document | First (Original) Ranking | Subsequent (Diverse) Ranking |
|---|---|---|
| a | 1 | 1 |
| b | 2 | 4 |
| c | 3 | 3 |
| d | 4 | 5 |
| e | 5 | 2 |

In one embodiment, a parameter α (alpha) indicates a degree to which the diversity ranking is to be applied in determining the presentation ranking. Where α is 1.0, the most diversity is sought in generating the presentation ranking. Conversely, where α is 0.0, the presentation ranking is the same as the first ranking, because no (zero) weight is given to the diversity factor when computing the presentation ranking. The diversity weighting parameter a may thus be used to weight, control, calibrate or the like the processes for determining the subsequent rankings.

In one embodiment, a “presentation score” is computed, which is the weighted sum of the two original first and subsequent rankings. The weights of the weighted sum are (1−α) and α, as shown in Equation 6, below.

presentation_score=[(1−α)*original_rank]+[α*diverse_rank] (Equation 6).

For example, where the value of α is 0.4, the documents a, b, c, d and e are assigned presention scores as shown in Table 2, below.

TABLE 2

| | | Subsequent | |
|---|---|---|---|
| | First | (Diverse) | |
| Document | Ranking | Ranking | Presentation score for α = 0.4 |
| a | 1 | 1 | [(1 − 0.4) × 1] + [0.4 × 1] = 1.0 |
| b | 2 | 4 | [(1 − 0.4) × 2] + [0.4 × 4] = 2.8 |
| c | 3 | 3 | [(1 − 0.4) × 3] + [0.4 × 3] = 3.0 |
| d | 4 | 5 | [(1 − 0.4) × 4] + [0.4 × 5] = 4.4 |
| e | 5 | 2 | [(1 − 0.4) × 5] + [0.4 × 2] = 3.8 |

In one implementation, a sorting is performed with the presentation score. This results in a new diversity-weighted rank, as shown in Table 3, below.

TABLE 3

| | | Subsequent | |
|---|---|---|---|
| | First | (Diverse) | |
| Document | Ranking | Ranking | Ranking with α = 0.4 |
| a | 1 | 1 | 1 |
| b | 2 | 4 | 2 |
| c | 3 | 3 | 3 |
| d | 4 | 5 | 5 |
| e | 5 | 2 | 4 |

In this example, for this particular value of the diversity weighting parameter α(α=0.4) documents d and e changed their ranking positions, relative to the first ranking.

### Specifying a Degree of Diversification

The weight given to the diversification factor in determining the presentation ranking of a set of items is referred to herein as the “degree of diversification”. As illustrated in the example given above, changes in the degree of diversification produce changes in the presentation ranking.

In one embodiment, the search engine sets the degree of diversification. In embodiments where the search engine sets the degree of diversification, the search engine may use a variety of factors to determine the degree. For example, the search engine may be designed to use an overall best setting, different settings for different users, different settings for different query types, different settings depending on the number of results per query, etc. Thus, the adjustment factors may include the nature of the search query. For example, for some types of queries, the system may use a high degree of diversification, while for other types of queries the system uses a low degree of diversification.

As another example, the search engine may vary the degree of diversification based on user-specific information. For example, for users that frequently click-through the items with the highest relevance ranking, the system may use a low degree of diversification. In contrast, for users that frequently click-through the items with lower relevance rankings, the system may use a higher degree of diversification. The system may also base the degree of diversification on a user's profile, or a user's stored preferences.

In other embodiments, another program sets the degree through an API. Specifically, instead of or in addition to having the system determine the degree of diversification, some embodiments include mechanisms that allow the degree of diversification to be specified by entities external to the search engine. For example, the degree of diversification may be specified by users, or by other computer programs that interact with the search engine.

In yet other embodiments, the user selects a value for α with a GUI based mechanism. The selected value of α is sent to the system. The system may use the specified value of α, or adjust the specified value based on additional factors. In the embodiments illustrated in FIGS. 2 and 3, the GUI based mechanism is a slider 211. Slider 211 includes a selector 212 that a user can drag horizontally across the range represented by the slider. As the user drags the selector 212 to the left, the degree of diversification decreases. As the user drags the selector 212 to the right, the degree of diversification increases.

Slider 211 is merely one example of a user interface control through which a user may specify a desired degree of diversity. The techniques described herein are not limited to any particular type of user control. For example, the user may be presented with a button that causes the presentation rankings to switch from fully-diversified to not-diversified, and visa-versa. Alternatively, the user may select the degree of diversification through a radio button, or a pull-down menu.

In one embodiment, a system-based API allows various applications to call for a diversity-enhanced search-related service, asking for search results for a query and for a particular diversity parameter, which relates to a degree of diversity desired in the search results. In response to these calls, search results are provided for the query, in which the results are ranked to the degree of diversity specified by the diversity parameter.

### Client-Side Refresh of Diversified Search Results

As mentioned above, a change in the degree of diversity typically results in a change in the presentation order of items. Consequently, when a user specifies a change to the degree of diversity for results that are already being presented, the results have to be re-presented based on the new presentation order. In one embodiment, the results are re-presented by sending the newly specified degree of diversity to the search engine, having the search engine determine a new presentation ranking based on the newly specified degree of diversity, and sending to the client a web page in which the items have be ranked according to the new presentation order.

To avoid the overhead associated with such system-side re-ranking and re-sending of the search results, mechanisms may be used to perform the re-ranking and re-displaying on the client without further involvement with the search engine. For example, in one embodiment, before providing any search results, the search engine computes presentation rankings for several different values of alpha (e.g., α=0.1, 0.2, etc.). Once the presentation rankings are computed for several vales of alpha, the search engine sends to the client (a) information that identifies the items, and (b) information that identifies the pre-computed presentation rankings.

Once this information is received by the client, the client presents the items based on the pre-computed presentation order that corresponds to the value of alpha currently specified by the user. If the user then changes the value of alpha (e.g. by moving selector 212), then the client refreshes the display of the items based on the pre-computed presentation order that corresponds to the newly specified value of alpha. Thus, the client is able to perform a client-side refresh that represents the items based on the newly specified degree of diversity without further involvement of the search engine.

In yet another embodiment, the search engine may not pre-compute the presentation ranking at various degrees of diversity. Instead, the search engine may simply send to the client the relevance rankings and diversity rankings for each item. With this information, client-side logic is able to compute for itself, without further involvement of the search engine, new presentation rankings in response to adjustments to the specified degree of diversity.

Various mechanisms may be used to implement such client-side refreshes. For example, one embodiment may use Asynchronous Java Script and XML (AJAX) techniques to dynamically reorder the search results in response to weight preference inputs. In alternative embodiments, the client-side refreshes may be performed by a browser plug-in, a Java applet, or Flash programming. AJAX (and the other solutions) enable the results to be instantaneously updated without the need to reload the entire page. The present invention is not limited to any particular mechanism for performing client-side re-presentation of search results in response to changes in the user-specified degree of diversity.

### Displaying an Indication of the Concepts Associated With the Set of Currently-Displayed Search Results

The top ranks of diversified search results tend to relate to a much wider range of topics than the top ranks of search results that have not been diversified. Consequently, when diversified search results are generated, it is particularly helpful to provide a visual indication to the user of topics relating to the items that are listed in the portion of the search results that is currently being presented to the user. The items that are identified in the portion of the search results that is being displayed to a user are referred to herein as the “currently-presented items”.

According to one embodiment, the search engine includes a mechanism for presenting to the user a “tag cloud” that is based on the currently-presented items. Such a tag cloud is referred to herein as a current-view-specific tag cloud. According to one embodiment, the current-view-specific tag cloud lists terms that are related to the topics associated with the currently-presented items. As the user transitions from page to page of the search results, the currently-presented items change. Since the currently-presented items are changed, and the search results have been diversified, the topics indicated in the tag cloud may change drastically.

A tag cloud 220 is illustrated in FIGS. 2 and 3. In the illustrated embodiment, the tag cloud 220 displays words or phrases in which the text size of a word indicates how strongly the words or phrases are related to the currently-presented items, relative to the other words and phrases in the tag cloud. Thus, in the tag cloud illustrated in FIG. 2, the phrase “buy flowers” is more strongly related to the items in listing 203, than the term “fanlisting”; the term “buy flowers” is therefore displayed in a larger font than “fanlisting” in the tag cloud. In the tag cloud illustrated in FIG. 3, there are fewer terms about buying flowers, and more terms about other topics. By looking at the tag cloud, a user can tell at a glance what topics are included in the currently-presented items.

In addition to displaying terms associated with the concepts of the currently-presented items, tag cloud 220 also serves as a mechanism by which the user may retrieve additional information about those concepts. Specifically, in one embodiment of the invention, each of the displayed terms is associated with a link that is activated when the user clicks on the term. When the link associated with a term is activated, a search is initiated for items that are strongly related to the concept represented by the term. For example, selecting the term “bird” in the tag cloud 220 of FIG. 3 initiates an operation to retrieve a listing of items that are strongly related to the concept “bird”.

According to one embodiment, the search engine uses the concept vectors associated with the currently-presented items to generate the tag cloud for the page that will contain the currently-presented items. Specifically, in one embodiment, before the search engine sends to the client a search results page that will list a particular set of items, the search engine:
obtains the concept vectors for the items that belong to the particular set
normalizes the concept weights within the concept vectors
aggregates the concept weights of concepts that are in more than one concept vector
selects a subset of the concepts based on their aggregate weights, and
generates a tag cloud based on the selected subset of concepts

The process of normalizing the concept weights is performed to ensure that the concepts of any given item are not treated disproportionately (underrepresented or overrepresented) in the tag cloud. This may be performed, for example, by scaling the concept weights in each concept vector either up or down based on the ratio of the concept vector's highest concept weight to some target weight. Alternatively, normalization may involve scaling the concept weights in each vector to achieve a specific total Euclidean length (the square root of the sum of the squares) that is the same across all vectors.

The process of selecting a subset of the concepts based on their aggregate weights may involve selecting all concepts that have aggregate concept weights above a certain threshold. Alternatively, the process of selecting a subset of concepts based on their aggregate weights may involve selecting the N highest-weighted concepts, where N is a target number of tags for the tag cloud. Yet another way of selecting the subset of concepts involves selecting the N highest-weighted concepts from the concept vector of each of the currently-presented items. Where N is the number of desired tags for the tag cloud divided by the number of currently-presented items.

In embodiments where the size of the tags reflects how strongly the concepts are related to the currently-presented items, the process of generating a tag cloud involves determining a font size for each tag based on the aggregate concept weight of the concept associated with the tag. In alternative embodiment, the relative weights of the tags may be visually communicated in other ways. For example, the tags may be presented in an order that is based on their respective aggregate concept weights. Alternatively, some other visual characteristic (e.g. font style, color, shading, etc.) may be used to visually communicate the aggregate concept weights of the tags.

### Hardware Overview

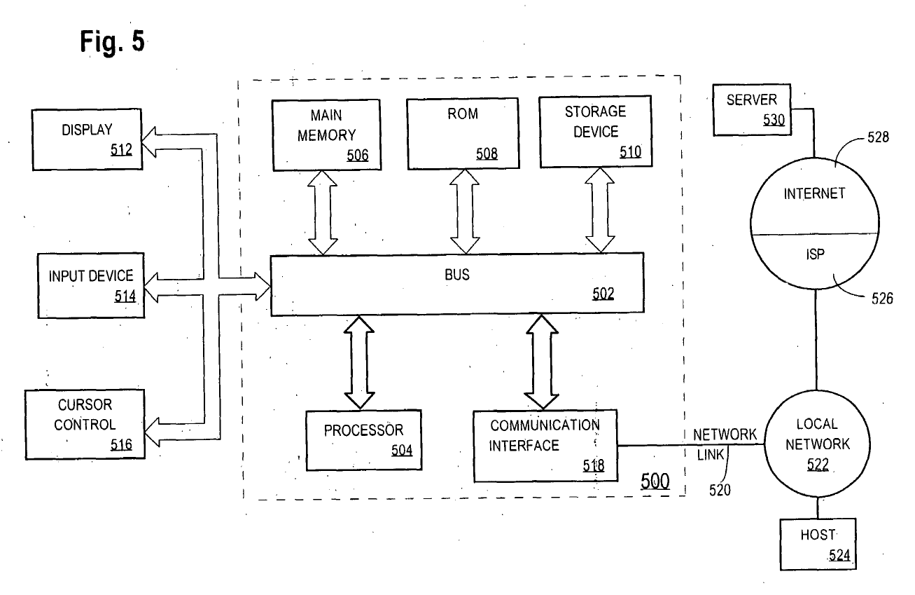

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input-device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for ranking items that belong to a set of items, comprising:
generating diversity scores for items that belong to said set of items based on how different the items are to other items that belong to said set of items; and
sending a message that presents said set of items in manner that is based, at least in part, on said diversity scores.

2. The method of claim 1 further comprising:
generating relevance scores for a plurality of items based on how relevant those items are to search terms contained in a search query; and
selecting said set of items from said plurality of items.

3. The method of claim 2 wherein the message is sent as a response to said search query.

4. The method of claim 1 wherein the message presents said set of items in an order that is based, at least in part, on said diversity scores.

5. The method of claim 2 further comprising selecting said set of items from among said plurality of items based, at least in part, on the relevance scores.

6. The method of claim 3 wherein the step of sending a message includes:
generating presentation scores for items in said set of items based, at least in part, on said relevance scores and said diversity scores; and
presenting said items in an order that is based on said presentation scores.

7. The method of claim 6 further comprising:
generating relevance rankings for said items based on the relevance scores; and
generating diversity rankings for said items based on the diversity scores;
wherein the step of generating presentation scores includes generating presentation scores based, at least in part, on the relevance rankings and the diversity rankings.

8. The method of claim 7 wherein the step of generating presentation scores for items in said set of items includes determining relative weights for the relevance rankings and diversity rankings based on a particular degree of diversity.

9. The method of claim 8 further comprising receiving input from a user that specifies said particular degree of diversity.

10. The method of claim 8 wherein:
the step of generating diversity rankings is performed by a search engine; and
the method further comprises receiving, at the search engine, a specified degree of diversity from an external program that is using searching services provided by the search engine.

11. The method of claim 8 further comprising determining said particular degree of diversity based on user-specific information associated with a user that submitted the search query.

12. The method of claim 8 wherein:
the step of generating diversity rankings is performed by a search engine in response to a search query;
the search engine generates the diversity rankings based on a degree of diversity; and
the degree of diversity is based, at least in part, on the type of said query.

13. The method of claim 8 wherein:
the step of generating diversity rankings is performed by a search engine in response to a search query submitted by a user;
the search engine generates the diversity rankings based on a degree of diversity; and
the degree of diversity is based, at least in part, on the user that submitted the query.

14. The method of claim 13 wherein the degree of diversity is based, at least in part, on whether the user that submitted the query frequently clicks-through items with lower presentation rankings.

15. The method of claim 13 wherein the degree of diversity is based, at least in part, on stored preferences of the user that submitted the query.

16. The method of claim 8 wherein:
the step of generating diversity rankings is performed by a search engine in response to a search query;
the search engine generates the diversity rankings based on a degree of diversity; and
the degree of diversity is based, at least in part, on how many results are produced by the query.

17. A method for ranking search results of a search query, comprising:
storing association information that associates concepts with items in a population;
receiving a search query for items in said population that match specified search criteria;
identifying a plurality of items, from said population, that match said search query;
assigning presentation rankings to each of said plurality of items;
identifying, based on the presentation rankings, a first subset of said items to be listed in a first search results web page;
generating, as the first search results web page, a web page that
(a) identifies items in the first subset of items, and
(b) includes a display of concepts;
wherein the concepts that are included in the display of concepts are selected exclusively based on concepts that said association information associates with the items in the first subset.

18. The method of claim 17 wherein the display of concepts is a tag cloud.

19. The method of claim 18 wherein:
the association information includes concept weight information that indicates the degrees to which items are related to the concepts with which the items are associated; and
at least one visual characteristic of tags in said tag cloud reflects the degrees to which items in the first subset are related to the concepts in the tag cloud.

20. The method of claim 17 wherein storing association information includes storing concept vectors for items in said population.

21. The method of claim 20 wherein the step of assigning presentation rankings includes:
determining diversity rankings based on said concept vectors; and
determining the presentation rankings based, at least in part, on said concept vectors.

22. A method for ranking a set of items, comprising:
(a) assigning diversity rankings to one or more items in the set of items;
(b) after step (a), for each item, in said set of items, that has not yet been assigned a diversity ranking, determining a diversity score that indicates a degree of difference between (i) the item and (ii) all items, from the set, that have already been assigned a diversity ranking; and
(c) based on the diversity scores determined in step (b), assigning diversity rankings to one or more items, from the set of items, that have not yet been assigned diversity rankings.

23. The method of claim 22 further comprising repeating steps (b) and (c) until all items in the set of items have been assigned diversity rankings.

24. The method of claim 22 wherein the step of determining a diversity score that indicates a degree of difference between (i) the item and (ii) all items, from the set, that have already been assigned a diversity ranking includes determining a diversity score that reflects differences in subject matter between the item and all items that have already been assigned a diversity ranking.

25. The method of claim 22 wherein the step of determining a diversity score that indicates a degree of difference between (i) the item and (ii) all items, from the set, that have already been assigned a diversity ranking includes determining a diversity score that reflects differences in source between the item and all items that have already been assigned a diversity ranking.

26. The method of claim 22 wherein the step of determining a diversity score that indicates a degree of difference between (i) the item and (ii) all items, from the set, that have already been assigned a diversity ranking includes determining a diversity score that reflects differences in geographic locations associated with the item and all items that have already been assigned a diversity ranking.

27. The method of claim 22 wherein the step of determining a diversity score that indicates a degree of difference between (i) the item and (ii) all items, from the set, that have already been assigned a diversity ranking includes determining a diversity score that reflects differences in author between the item and all items that have already been assigned a diversity ranking.

28. The method of claim 22 wherein the step of determining a diversity score that indicates a degree of difference between (i) the item and (ii) all items, from the set, that have already been assigned a diversity ranking includes determining a diversity score that reflects differences in item type between the item and all items that have already been assigned a diversity ranking.

29. The method of claim 22 wherein the step of determining a diversity score that indicates a degree of difference between (i) the item and (ii) all items, from the set, that have already been assigned a diversity ranking includes determining a diversity score that reflects differences in prices associated with the item and all items that have already been assigned a diversity ranking.

30. The method of claim 22 wherein:
the set of items are items from search results produced in response to a search query; and
the method further includes determining a presentation ranking for the search results based, at least in part, on the diversity rankings.

31. A method of presenting search results, the method comprising:
receiving a search query at a search engine;
in response to the search query, the search engine performing the steps of
generating a plurality of rankings for items in said search results, wherein each ranking of the plurality of rankings ranks said items using a different ranking criteria; and
responding to the search query by sending to a client a response that includes ranking data;
wherein the ranking data is based on said plurality of rankings and allows the client to generate a display in which the items are ranked in a presentation ranking that is based on relative weights assigned to said rankings, and to change the relative weights, and thereby change the presentation ranking, without requiring said dent to interact further with said search engine.

32. The method of claim 31 wherein:
the search engine precomputes a plurality of presentation rankings;
each presentation ranking of the plurality of presentation rankings is based on assigning different relative weights to said plurality of rankings; and
the ranking data indicates said plurality of presentation rankings.

33. The method of 31 wherein the ranking data indicates said plurality of rankings, thereby allowing the client to compute different presentation rankings by assigning different relative weights to said plurality of rankings.

34. The method of claim 31 wherein the step of generating a plurality of rankings includes:
generating a first ranking of said items based on a first degree of diversity;
generating a second ranking of said items based on a second degree of diversity; and
wherein the plurality of rankings include the first ranking and the second ranking.

35. A method for presenting search results, the method comprising:
receiving from a search engine, at a client, a response to a search query;
wherein the response includes ranking data that is based on a plurality of rankings performed by the search engine,
wherein each of the plurality of rankings rank a plurality of items that match the search query;
at the client, displaying the plurality of items in a first presentation ranking that reflects a first set of relative weights for said plurality of rankings; and
in response to user input at the client, without further interaction with the search engine, redisplaying the plurality of items in a second presentation ranking that reflects a second set of relative weights for said plurality of rankings.

36. The method of claim 35 wherein:
the search engine precomputes a plurality of presentation rankings;
each presentation ranking of the plurality of presentation rankings is based on assigning different relative weights to said plurality of rankings; and
the ranking data indicates said plurality of presentation rankings.

37. The method of 35 wherein:
the ranking data indicates said plurality of rankings, and
the client computes at least one of the first presentation ranking and the second presentation ranking based on the ranking data.

38. The method of claim 35 wherein:
the first presentation ranking is based on a first degree of diversity; and
the second presentation ranking is based on a second degree of diversity.

39. The method of claim 35 wherein the step of displaying a search results listing includes displaying a web page.

40. The method of claim 35 where the user input involves interaction with a control.

41. The method of claim 40 wherein the control is a slider.

42. A method comprising:
generating diversity scores for a plurality of items based on how different the items are to other items of said plurality of items; and
determining a set of items to list in a response to a search query based, at least in part, on the diversity scores; and
in response to said search query, sending said response that lists said set of items.

43. The method of claim 42 further comprising:
generating relevance scores for said plurality of items based on how relevant those items are to search terms contained in said search query; and
determining said set of items to list based, at least in part, on said relevance scores.

44. The method of claim 42 wherein the response presents said set of items in an order that is based, at least in part, on said diversity scores.

45. The method of claim 44 further comprising:
generating presentation scores for items in said set of items based, at least in part, on said relevance scores and said diversity scores; and
presenting said items in an order that is based on said presentation scores.

46. The method of claim 30 further comprising:
generating relevance rankings for said items based on the relevance scores; and
generating diversity rankings for said items based on the diversity scores;
wherein the step of generating presentation scores includes generating presentation scores based, at least in part, on the relevance rankings and the diversity rankings.

47. The method of claim 46 wherein the step of generating presentation scores for items in said set of items includes determining relative weights for the relevance rankings and diversity rankings based on a particular degree of diversity.

48. The method of claim 47 further comprising receiving input from a user that specifies said particular degree of diversity.

49. The method of claim 47 wherein:
the step of generating diversity rankings is performed by a search engine; and
the method further comprises receiving, at the search engine, a specified degree of diversity from an external program that is using searching services provided by the search engine.

50. The method of claim 47 further comprising determining said particular degree of diversity based on user-specific information associated with a user that submitted the search query.

51. The method of claim 47 wherein:
the step of generating diversity rankings is performed by a search engine in response to a search query;
the search engine generates the diversity rankings based on a degree of diversity; and
the degree of diversity is based, at least in part, on the type of said query.

52. The method of claim 47 wherein:
the step of generating diversity rankings is performed by a search engine in response to a search query submitted by a user;
the search engine generates the diversity rankings based on a degree of diversity; and
the degree of diversity is based, at least in part, on the user that submitted the query.

53. The method of claim 52 wherein the degree of diversity is based, at least in part, on whether the user that submitted the query frequently clicks-through items with lower presentation rankings.

54. The method of claim 52 wherein the degree of diversity is based, at least in part, on stored preferences of the user that submitted the query.

55. The method of claim 47 wherein:
the step of generating diversity rankings is performed by a search engine in response to a search query;
the search engine generates the diversity rankings based on a degree of diversity; and
the degree of diversity is based, at least in part, on how many results are produced by the query.

56. A computer-readable medium carrying one or more sequences of instructions which, when executed by one or more processors, causes the one or more processors to perform the method recited in claim 1.

57. A computer-readable medium carrying one or more sequences of instructions which, when executed by one or more processors, causes the one or more processors to perform the method recited in claim 2.

58. A computer-readable medium carrying one or more sequences of instructions which, when executed by one or more processors, causes the one or more processors to perform the method recited in claim 3.

59. A computer-readable medium carrying one or more sequences of instructions which, when executed by one or more processors, causes the one or more processors to perform the method recited in claim 4.

60. A computer-readable medium carrying one or more sequences of instructions which, when executed by one or more processors, causes the one or more processors to perform the method recited in claim 5.

61. A computer-readable medium carrying one or more sequences of instructions which, when executed by one or more processors, causes the one or more processors to perform the method recited in claim 6.

62. A computer-readable medium carrying one or more sequences of instructions which, when executed by one or more processors, causes the one or more processors to perform the method recited in claim 7.

63. A computer-readable medium carrying one or more sequences of instructions which, when executed by one or more processors, causes the one or more processors to perform the method recited in claim 8.

64. A computer-readable medium carrying one or more sequences of instructions which, when executed by one or more processors, causes the one or more processors to perform the method recited in claim 9.

65. A computer-readable medium carrying one or more sequences of instructions which, when executed by one or more processors, causes the one or more processors to perform the method recited in claim 10.

66. A computer-readable medium carrying one or more sequences of instructions which, when executed by one or more processors, causes the one or more processors to perform the method recited in claim 11.

67. A computer-readable medium carrying one or more sequences of instructions which, when executed by one or more processors, causes the one or more processors to perform the method recited in claim 12.

68. A computer-readable medium carrying one or more sequences of instructions which, when executed by one or more processors, causes the one or more processors to perform the method recited in claim 13.

69. A computer-readable medium carrying one or more sequences of instructions which, when executed by one or more processors, causes the one or more processors to perform the method recited in claim 14.

70. A computer-readable medium carrying one or more sequences of instructions which, when executed by one or more processors, causes the one or more processors to perform the method recited in claim 15.

71. A computer-readable medium carrying one or more sequences of instructions which, when executed by one or more processors, causes the one or more processors to perform the method recited in claim 16.

72. A computer-readable medium carrying one or more sequences of instructions which, when executed by one or more processors, causes the one or more processors to perform the method recited in claim 17.

73. A computer-readable medium carrying one or more sequences of instructions which, when executed by one or more processors, causes the one or more processors to perform the method recited in claim 18.

74. A computer-readable medium carrying one or more sequences of instructions which, when executed by one or more processors, causes the one or more processors to perform the method recited in claim 19.

75. A computer-readable medium carrying one or more sequences of instructions which, when executed by one or more processors, causes the one or more processors to perform the method recited in claim 20.

76. A computer-readable medium carrying one or more sequences of instructions which, when executed by one or more processors, causes the one or more processors to perform the method recited in claim 21.

77. A computer-readable medium carrying one or more sequences of instructions which, when executed by one or more processors, causes the one or more processors to perform the method recited in claim 22.

78. A computer-readable medium carrying one or more sequences of instructions which, when executed by one or more processors, causes the one or more processors to perform the method recited in claim 23.

79. A computer-readable medium carrying one or more sequences of instructions which, when executed by one or more processors, causes the one or more processors to perform the method recited in claim 24.

80. A computer-readable medium carrying one or more sequences of instructions which, when executed by one or more processors, causes the one or more processors to perform the method recited in claim 25.

81. A computer-readable medium carrying one or more sequences of instructions which, when executed by one or more processors, causes the one or more processors to perform the method recited in claim 26.

82. A computer-readable medium carrying one or more sequences of instructions which, when executed by one or more processors, causes the one or more processors to perform the method recited in claim 27.

83. A computer-readable medium carrying one or more sequences of instructions which, when executed by one or more processors, causes the one or more processors to perform the method recited in claim 28.

84. A computer-readable medium carrying one or more sequences of instructions which, when executed by one or more processors, causes the one or more processors to perform the method recited in claim 29.

85. A computer-readable medium carrying one or more sequences of instructions which, when executed by one or more processors, causes the one or more processors to perform the method recited in claim 30.

86. A computer-readable medium carrying one or more sequences of instructions which, when executed by one or more processors, causes the one or more processors to perform the method recited in claim 31.

87. A computer-readable medium carrying one or more sequences of instructions which, when executed by one or more processors, causes the one or more processors to perform the method recited in claim 32.

88. A computer-readable medium carrying one or more sequences of instructions which, when executed by one or more processors, causes the one or more processors to perform the method recited in claim 33.

89. A computer-readable medium carrying one or more sequences of instructions which, when executed by one or more processors, causes the one or more processors to perform the method recited in claim 34.

90. A computer-readable medium carrying one or more sequences of instructions which, when executed by one or more processors, causes the one or more processors to perform the method recited in claim 35.

91. A computer-readable medium carrying one or more sequences of instructions which, when executed by one or more processors, causes the one or more processors to perform the method recited in claim 36.

92. A computer-readable medium carrying one or more sequences of instructions which, when executed by one or more processors, causes the one or more processors to perform the method recited in claim 37.

93. A computer-readable medium carrying one or more sequences of instructions which, when executed by one or more processors, causes the one or more processors to perform the method recited in claim 38.

94. A computer-readable medium carrying one or more sequences of instructions which, when executed by one or more processors, causes the one or more processors to perform the method recited in claim 39.

95. A computer-readable medium carrying one or more sequences of instructions which, when executed by one or more processors, causes the one or more processors to perform the method recited in claim 40.

96. A computer-readable medium carrying one or more sequences of instructions which, when executed by one or more processors, causes the one or more processors to perform the method recited in claim 41.

97. A computer-readable medium carrying one or more sequences of instructions which, when executed by one or more processors, causes the one or more processors to perform the method recited in claim 42.

98. A computer-readable medium carrying one or more sequences of instructions which, when executed by one or more processors, causes the one or more processors to perform the method recited in claim 43.

99. A computer-readable medium carrying one or more sequences of instructions which, when executed by one or more processors, causes the one or more processors to perform the method recited in claim 44.

100. A computer-readable medium carrying one or more sequences of instructions which, when executed by one or more processors, causes the one or more processors to perform the method recited in claim 45.

101. A computer-readable medium carrying one or more sequences of instructions which, when executed by one or more processors, causes the one or more processors to perform the method recited in claim 46.

102. A computer-readable medium carrying one or more sequences of instructions which, when executed by one or more processors, causes the one or more processors to perform the method recited in claim 47.

103. A computer-readable medium carrying one or more sequences of instructions which, when executed by one or more processors, causes the one or more processors to perform the method recited in claim 48.

104. A computer-readable medium carrying one or more sequences of instructions which, when executed by one or more processors, causes the one or more processors to perform the method recited in claim 49.

105. A computer-readable medium carrying one or more sequences of instructions which, when executed by one or more processors, causes the one or more processors to perform the method recited in claim 50.

106. A computer-readable medium carrying one or more sequences of instructions which, when executed by one or more processors, causes the one or more processors to perform the method recited in claim 51.

107. A computer-readable medium carrying one or more sequences of instructions which, when executed by one or more processors, causes the one or more processors to perform the method recited in claim 52.

108. A computer-readable medium carrying one or more sequences of instructions which, when executed by one or more processors, causes the one or more processors to perform the method recited in claim 53.

109. A computer-readable medium carrying one or more sequences of instructions which, when executed by one or more processors, causes the one or more processors to perform the method recited in claim 54.

110. A computer-readable medium carrying one or more sequences of instructions which, when executed by one or more processors, causes the one or more processors to perform the method recited in claim 55.
